(19) United States
(12) Patent Application Publication
(10) Pub. No.: US 2009/0140964 A1
(43) Pub. Date: Jun. 4, 2009

(54) METHOD OF PROCESSING LCD IMAGES ACCORDING TO CONTENT OF THE IMAGES

(76) Inventor: Ching-Yueh Chiang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/277,314

(22) Filed: Nov. 25, 2008

(30) Foreign Application Priority Data
Dec. 3, 2007 (TW) 096145932

(51) Int. Cl. G09G 3/36

(52) U.S. Cl. 345/87

(57) ABSTRACT

An LCD turns on the black image insertion function when displaying motion images for reducing motion blur, and turns off the black image insertion function when displaying still images to avoid a flicker. Further, the LCD utilizes a set of gamma curves for black image insertion. The LCD stores a plurality of successive frames to a frame memory, and analyzes content of preceding frames and following frames of each frame so as to generate a difference. When the difference is greater than a predetermined value, correspond the brightness of the first half period of the frame to a high gamma curve and the brightness of the second half period of the frame to a low gamma curve so as to reduce the flicker resulted from the black image insertion.

### BACKGROUND OF THE INVENTION

1. Field of the Invention

The present invention relates to a method of processing LCD images, and more particularly, to a method of processing LCD images according to content of the images.

2. Description of the Prior Art

A Liquid Crystal Display (LCD) generates different gray levels by controlling the angle of the liquid crystal so as to allow different amount of light passing through the liquid crystal. In contrast to a cathode ray tube (CRT) display which uses an impulse-type driving method, the LCD display uses a hold-type driving method. Since the liquid crystal rotates continuously, the LCD cannot display a picture as fast as the CRT, and the motion blur phenomenon occurs when the LCD displays a moving object. In order to reduce the motion blur phenomenon, the LCD utilizes the black image insertion technique to simulate the impulse-type driving method of the CRT display; for example, the black image can be implemented with a flashing backlight or driving circuits. However, the black image insertion will cause the LCD to produce a flicker and unstable luminance. Though an increased number of black image insertions reduces motion blur, but at the same time intensifies the flicker.

Please refer to FIG. 1. FIG. 1 is a schematic diagram illustrating a method of the black image insertion according to the prior art. Part A in FIG. 1 is a display signal of a CRT display. Part B in FIG. 1 is a display signal of an LCD. In FIG. 1A and FIG. 1B, the horizontal axis represents time period and the vertical axis represents the luminance. The display signal is represented in three frames. The luminance of the frame 1 is 3; the luminance of the frame 2 is 2; the luminance of the frame 3 is 1. In FIG. 1B, the LCD utilizes the black image insertion techniques. Assuming the duration of one frame is T, the LCD holds the luminance of the display signal for the first period T/2, and decreases the luminance of the display signal to 0 for the second period T/2, that is, a black image. When a black image is inserted between two original frames, the LCD has to transmit the display data and the black data. Thus, the frequency of the LCD transmitting data is doubled because of the double data quantity (the display data and the inserted black images) while the frame rate of the LCD keeps the same. For example, if the frame rate of the LCD is 60 Hz, the frequency of the LCD transmitting data with the black image insertion is 120 Hz.

The black image insertion technique can reduce the motion blur of the LCD, but will produce a flicker, especially when the LCD displays the same luminance for several successive frames. Please refer to FIG. 2. FIG. 2 is a schematic diagram illustrating the flicker caused by the method of the black image insertion according to the prior art. FIG. 2A is the display signal of the LCD without the black image insertion. FIG. 2B is the display signal of the LCD with the black image insertion. Assuming the luminance of the display signal for frame 1 to frame 3 is 2, the LCD has no flicker when a user watches the LCD driven by the display signal in FIG. 2A. However, when the user watches the LCD driven by the display signal in FIG. 2B, the luminance of frame 1 is 2 for the first half period, and 0 for the second half period; the luminance of frame 2 is 2 for the first half period, and 0 for the second half period; the luminance of frame 3 is 2 for the first half period, and 0 for the second half period. Accordingly, the user is certainly troubled by the flicker of the LCD. Thus though the black image insertion technique can reduce the motion blur of the LCD, it will produce a flicker, which lowers the quality of the LCD.

### SUMMARY OF THE INVENTION

According to an embodiment of the present invention, a method of processing LCD images according to content of the images comprises analyzing content of a plurality of successive frames of an LCD so as to generate a difference, inserting a black image after each frame of the plurality of successive frames when the difference is greater than a predetermined value, and displaying content of the plurality of successive frames and the plurality of inserted black images.

According to another embodiment of the present invention, a method of processing LCD images according to content of the images comprises analyzing content of a plurality of successive frames of an LCD so as to generate a difference, and displaying content of the plurality of successive frames when the difference is smaller than a predetermined value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a method of the black image insertion according to the prior art.

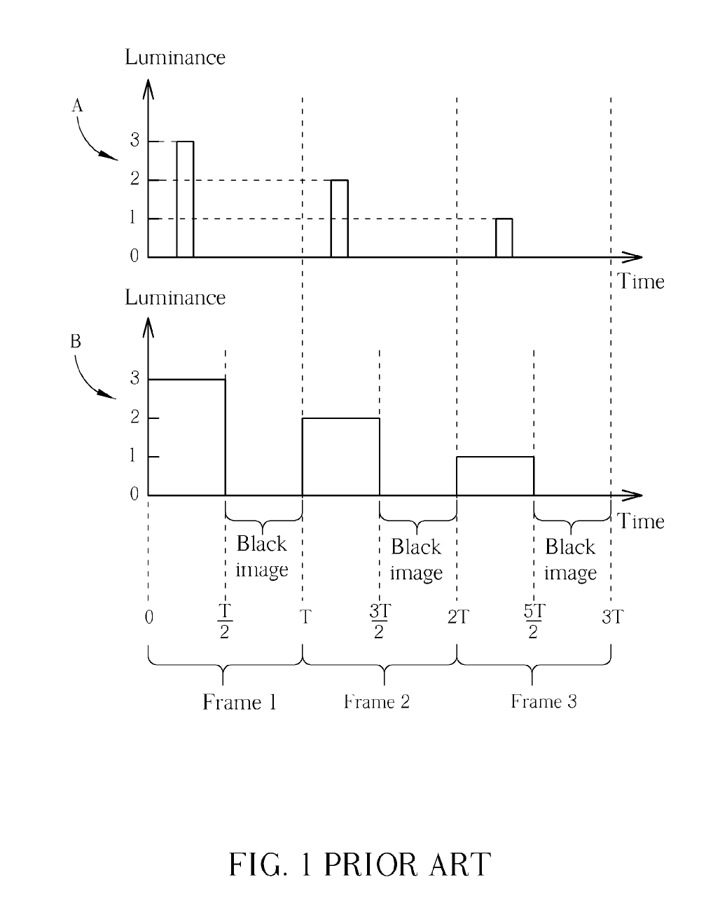

FIG. 2 is a schematic diagram illustrating the flicker caused by the method of the black image insertion according to the prior art.

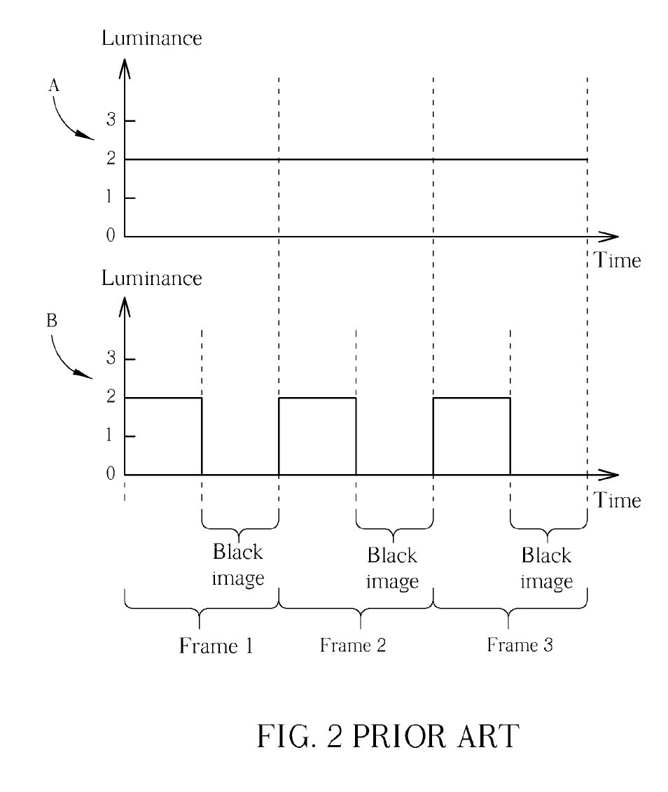

FIG. 3 is a diagram of an image processing system of an LCD according to the present invention.

FIG. 4 is a diagram of a first set of gamma curves in the present invention.

FIG. 5 is a diagram of a second set of gamma curves in the present invention.

FIG. 6 is a flowchart of processing LCD images according to content of the images according to the present invention.

### DETAILED DESCRIPTION

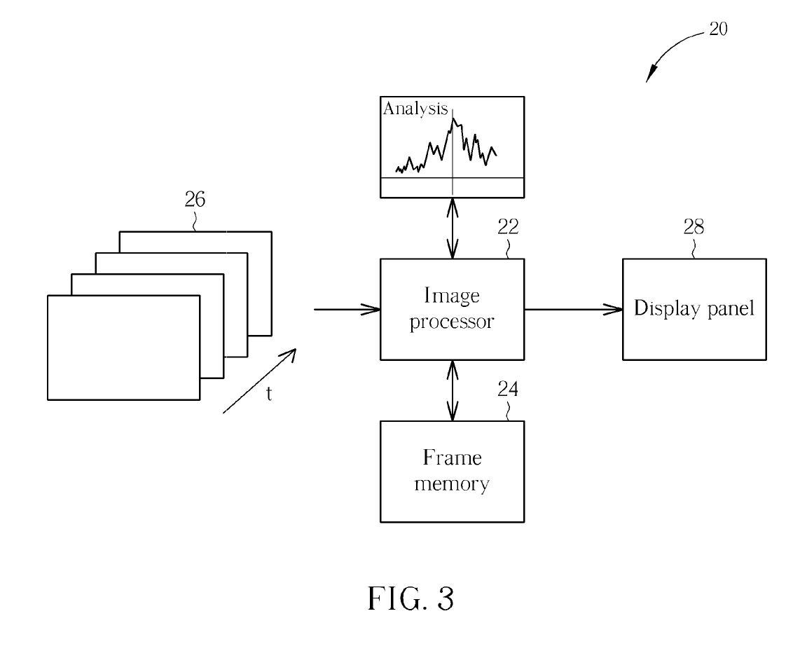

Please refer to FIG. 3. FIG. 3 is a diagram of an image processing system 20 of an LCD according to the present invention. The LCD utilizes the black image insertion to reduce motion blur when displaying motion images, but the black image insertion causes a flicker when displaying a still image. Thus, the LCD according to the present invention utilizes the image processing system 20 to analyze input image signals so that the LCD turns on the black image insertion function to improve the motion blur when displaying the motion images and turns off the black image insertion function to prevent the flicker when displaying the still image. The image processing system 20 comprises an image processor 22, a frame memory 24, a plurality of frame data 26, and a display panel 28. The image signal inputted to the LCD comprises the plurality of frame data 26. The image processor 22 receives the plurality of frame data 26 and then stores in the frame memory 24 for analyzing. The image processor 22 analyzes the difference of n successive frames of the frame data 26 each time, so the size of the frame memory 24 is capable of storing at least n frame data. Basically, a greater n is beneficial to the analysis of the image difference, but a larger size of the frame memory 24 is needed and longer time is taken by the image processor 22 to analyze the frame data 26. In the embodiment of the present invention, n=4 for example, the image processor 22 analyzes the frame data of four successive frames including one preceding frame and two following frames for each frame to generate an analysis result. The analysis result is compared with a predetermined value for determining if the LCD turns on the black image insertion function when displaying the frame data. For example, when the LCD displays the second frame data, the image processor 22 stores the first frame data to the fourth frame data in the frame memory 24, and analyzes the difference of the four frame data to determine if a black image is to be inserted in the second frame data.

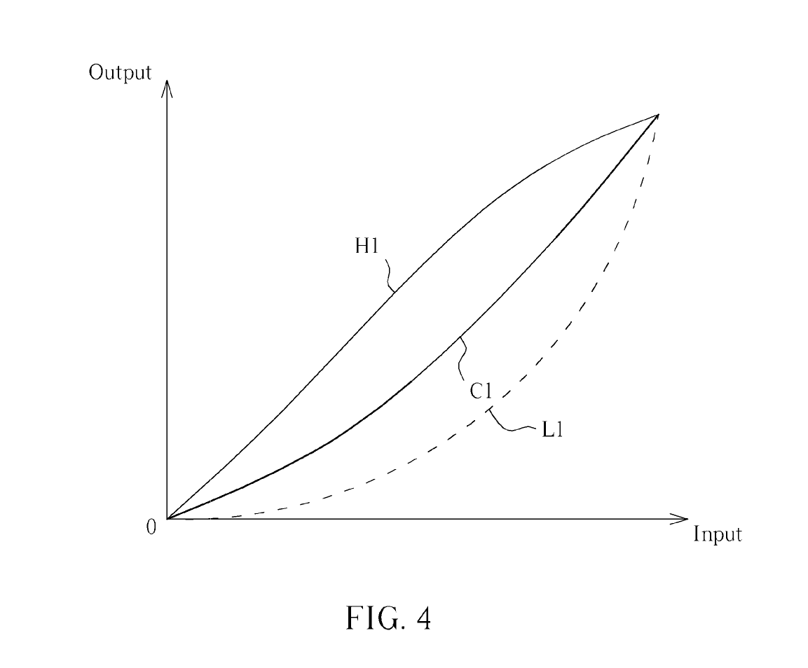

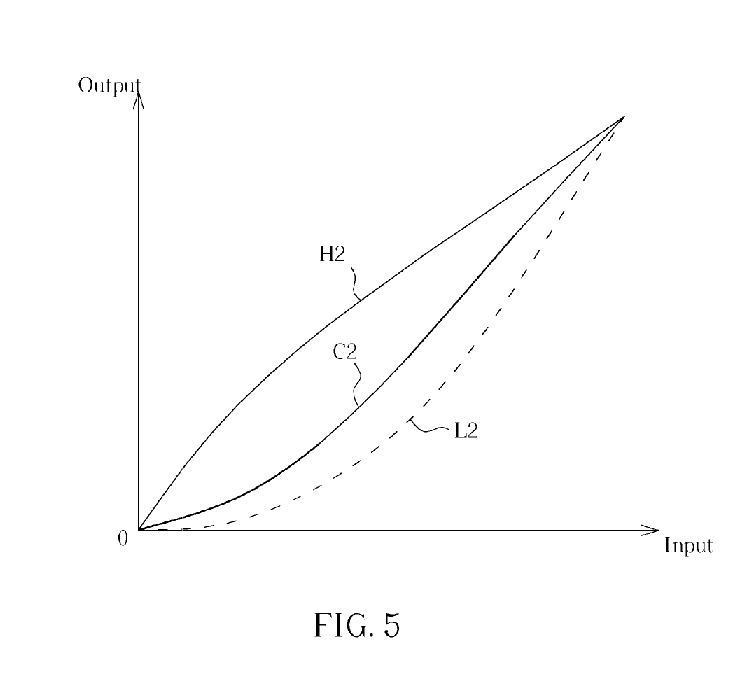

Please refer to FIG. 4 and FIG. 5. FIG. 4 is a diagram of a first set of gamma curves in the present invention. FIG. 5 is a diagram of a second set of gamma curves in the present invention. In general, a gray level to luminance transformation of a display device can be represented with the gamma curves. The input of the display device is charted by X-axis (0˜255 gray levels) and the output of the display device is charted by Y-axis (luminance) so as to generate the gamma curves. The gamma curves correspond to a function called gamma function. The gamma function of a display device can be represented as Y=(X+e)̂r, where Y is the luminance, X is the output voltage, e is the compensation factor, and r is the gamma value. In the embodiment of the present invention, the black image insertion is implemented with a set of gamma curves. As shown in FIG. 4, the first gray level to luminance transformation is the low gamma curve L1, of which the gamma value is smaller than the gamma value of the predetermined gamma curve C1; the second gray level to luminance transformation is the high gamma curve H1, of which the gamma value is greater than the gamma value of the predetermined gamma curve C1. When the LCD turns on the black image insertion function, the luminance of the first half period of the frame is generated according to the high gamma curve H1, and the luminance of the second half period of the frame is generated according to the low gamma curve L1. When the LCD turns off the black image insertion, the luminance of the frame is generated according to the predetermined gamma curve C1. According to the embodiment of the black image insertion given above, the luminance difference between the first half period and the second half period in one frame is not as large as the prior art since the second half period of the frame is not a full black image. Thus, the user will not feel a big difference, so the flicker caused by the black image insertion can be reduced.

When the LCD turns on the black image insertion function, the luminance of the first half period of the frame is corresponding to the high gamma curve H1, and the luminance of the second half period of the frame is corresponding to the high gamma curve L1. The luminance of the frame of the LCD generated according to the high gamma curve H1 and the low gamma curve L1 has to equal the luminance of the frame of LCD generated according to the predetermined gamma curve C1, which is measured by a color analyzer, so that the LCD can keep the average luminance the same, and the darkening of the LCD would not be noticed. For example, when the gray level of a frame is 50 and the corresponding luminance according to the predetermined gamma curve C1 is 5, the luminance of the second half period of the frame according to the low gamma curve L1 is set to 2 corresponding to the gray level 50. Based on these criteria, the high gamma curve H1 can be define by adjusting the luminance of the first half period of the frame and then utilizing the color analyzer to measure the luminance of the entire frame. When the luminance of first half period of the frame is adjusted to 9 and the luminance of the entire frame measured by the color analyzer is 5, the luminance of the first half period of the frame according to high gamma curve H1 is defined to 9 corresponding to the gray level 50. If the gray level of the LCD can be varied from 0 to 255, then the color analyzer will measure the LCD 255 times respectively for 255 gray levels so as to generate the high gamma curve H1. According to the method above, a plurality of gamma curves can be generated, such as the second set of gamma curves as shown in FIG. 5 including the predetermined gamma curves C2, high gamma curves H2, and low gamma curves L2. When the image processing system 20 comprises more than two sets of gamma curves, the image processing system 20 can select one set of gamma curves applied in the black image insertion according to the analysis result of the plurality of frame data 26.

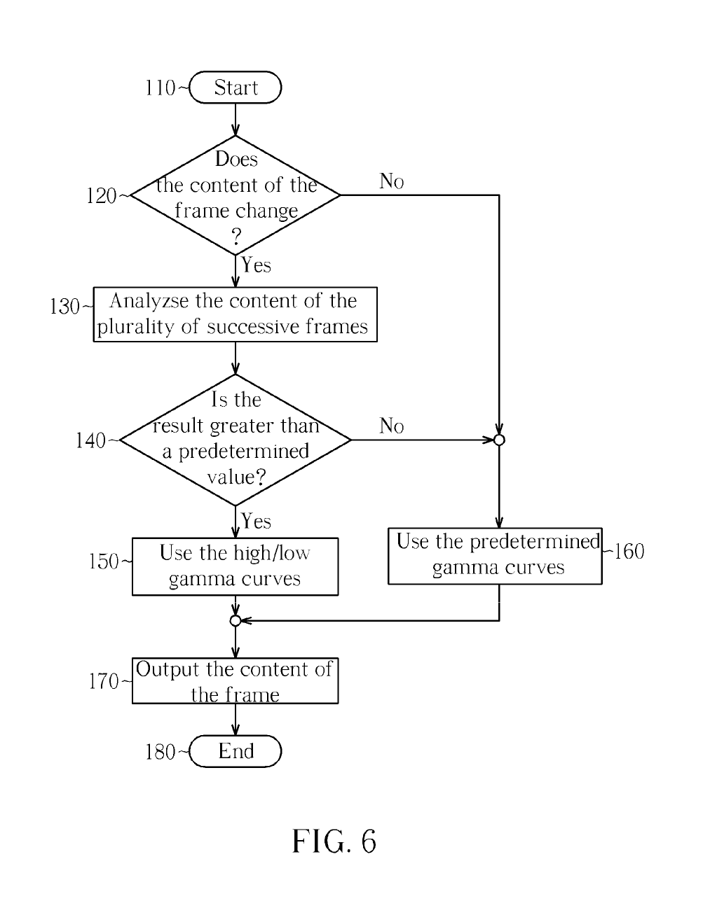

Please refer to FIG. 6. FIG. 6 is a flowchart of processing LCD images according to the present invention. In the embodiment of the present invention, the LCD processes the images according to content of the images comprises the following steps:

Step 110: An LCD receives an image signal comprising a plurality of successive frames, and stores the plurality of successive frames in a frame memory.

Step 120: Determine if content of the plurality of successive frames changes. If content of the plurality of successive frames is the same, it means that the LCD displays a still image, then go to Step 160. If content of the plurality of successive frames is different, it means that the LCD displays motion images, then go to Step 130.

Step 130: Content of the preceding frames and the following frames of each frame stored in the frame memory is analyzed to generate a difference, and one set of gamma curves is selected accordingly.

Step 140: The analysis result in Step 130 is compared with a predetermined value. If the difference is greater than the predetermined value, it means that the LCD needs to turn on the black image insertion function to improve the motion blur, then go to Step 150. If the difference is smaller than the predetermined value, it means that the LCD can turn off the black image insertion function, then go to Step 160.

Step 150: The luminance of first half period of the frame is generated according to the high gamma curves, and the luminance of second half period of the frame is generated according to the low gamma curves.

Step 160: The luminance of the frame is generated according to the predetermined gamma curves.

Step 170: The LCD displays content of the frame.

Step 180: End.

In conclusion, the LCD utilizes black image insertion to improve motion blur when displaying motion images, but the black image insertion causes the flicker when displaying a still image. The LCD of the present invention turns on the black image insertion function when displaying motion images for reducing the motion blur, and turns off the black image insertion function when displaying still images to avoid the flicker. Further, the LCD utilizes a set of gamma curves for black image insertion. The LCD stores a plurality of successive frames to a frame memory, and analyzes content of the preceding frames and the following frames of each frame so as to generate a difference. When the difference is greater than a predetermined value, correspond the brightness of the first half period of the frame to a high gamma curve and the brightness of the second half period of the frame to a low gamma curve so as to reduce the flicker resulted from the black image insertion.

Those skilled in the art will readily observe that numerous modifications and alterations of the device and method may be made while retaining the teachings of the invention.

What is claimed is:

1. A method of processing LCD (Liquid Crystal Display) images according to content of the images, the method comprising:
analyzing content of a plurality of successive frames of an LCD so as to generate a difference;
inserting a black image after each frame of the plurality of successive frames when the difference is greater than a predetermined value; and
displaying content of the plurality of successive frames and the plurality of inserted black images.

2. The method of claim 1, wherein inserting the black image after each frame of the plurality of successive frames when the difference is greater than the predetermined value is inserting a black image generated according to a first gray level to luminance transformation after each frame of the plurality of successive frames when the difference is greater than the predetermined value.

3. The method of claim 1, wherein inserting the black image after each frame of the plurality of successive frames when the difference is greater than the predetermined value comprises:
adjusting content of the plurality of the successive frames according to a second gray level to luminance transformation; and
inserting the black image generated according to a first gray level to luminance transformation.

4. The method of claim 1, wherein inserting the black image after each frame of the plurality of successive frames when the difference is greater than the predetermined value is inserting the black image after each frame and displaying the frame and the black image in one frame time when the difference is greater than the predetermined value.

5. The method of claim 1, wherein inserting the black image after each frame of the plurality of successive frames when the difference is greater than the predetermined value is inserting the black image generated according to a first gamma value after each frame of the plurality of successive frames when the difference is greater than the predetermined value, wherein the first gamma value is smaller than a predetermined gamma value.

6. The method of claim 1, wherein inserting the black image after each frame of the plurality of successive frames when the difference is greater than the predetermined value comprises:
adjusting content of the plurality of the successive frames according to a second gamma value, wherein the second gamma value is greater than a predetermined gamma value; and
inserting the black image generated according to a first gamma value, wherein the first gamma value is smaller than the predetermined gamma value.

7. The method of claim 1, further comprising:
providing a frame memory for storing content of the plurality of successive frames.

8. A method of processing LCD (Liquid Crystal Display) images according to content of the images, the method comprising:
analyzing content of a plurality of successive frames of an LCD so as to generate a difference; and
displaying content of the plurality of successive frames when the difference is smaller than a predetermined value.

9. The method of claim 8, wherein displaying content of the plurality of successive frames when the difference is smaller than the predetermined value is displaying content of the plurality of successive frames according to a predetermined gamma value when the difference is smaller than the predetermined value.

10. The method of claim 8, further comprising: providing a frame memory for storing content of the plurality of successive frames.
